(19) United States
(12) Patent Application Publication
(10) Pub. No.: US 2024/0367153 A1
(43) Pub. Date: Nov. 7, 2024

(54) BIOCIDAL NANOCOMPOSITE COMPRISING A PHOTOCATALYST

(71) Applicant: CEYLON GRAPHITE CORP, Vancouver (CA)

(72) Inventor: Henagama Liyanage Mallika BOHM, Cambridgeshire (GB)

(21) Appl. No.: 18/553,805

(22) PCT Filed: Mar. 3, 2022
(86) PCT No.: PCT/GB2022/050563

§ 371 Date: Oct. 3, 2023

(30) Foreign Application Priority Data
Mar. 3, 2021 (GB) 2102984.8

(51) Int. Cl. B01J 21/06; A01N 25/08; A01N 25/10; A01N 59/16; A01N 59/20; A01P 1/00; B01J 21/18; B01J 23/50; B01J 23/72; B01J 31/12; B01J 31/38; B01J 35/39; B01J 35/45; B01J 37/00; B01J 37/02; B01J 37/04

(52) U.S. Cl. CPC B01J 21/063; A01N 25/08; A01N 25/10; A01N 59/16; A01N 59/20; A01P 1/00; B01J 21/18; B01J 23/50; B01J 23/72; B01J 31/122; B01J 31/38; B01J 35/39; B01J 35/45; B01J 37/0009; B01J 37/0219; B01J 37/04

(57) ABSTRACT

The present invention relates to a biocidal nanocomposite comprising graphene, a photocatalyst and a biocide and to coatings comprising the same.

### TECHNICAL FIELD OF THE INVENTION

The present invention relates to a biocidal nanocomposite, to a method of preparing a biocidal nanocomposite, to a coating comprising the biocidal nanocomposite and to a coated substrate comprising the biocidal nanocomposite.

### BACKGROUND TO THE INVENTION

Emerging infectious diseases (EIDs) constitute a global concern for public health and safety and the prevention or control of microbial contamination requires effective and efficient contact killing technology. Many types of anti-microbial materials and irradiation technologies are known for disinfecting hard surfaces. The most employed methods of disinfecting a contaminated surface by microorganisms is to use a solution of surfactant, an alcohol or a bleach in minimum effective concentrations. The disinfection rate of these solution depends on the strength of the cleaning solution, the extent of contamination and the contact time. Each of these methods suffer from the disadvantage that they require manual decontamination which is tedious and time-consuming, and persistent contamination is common even after cleaning.

Alternative disinfection methods involve the use biocides, such as organic molecules and metal nanoparticles. However, their immediate biocidal effect usually suffers from significant decline due to the irreversible consumption of the biocides. Higher loading of the biocide is limited by the maximum tolerated dose for each of these materials.

The use of ultraviolet (UVC) germicidal irradiation is extremely effective technology for preventing the spread of microbial contamination and it is known to be able to kill 99% of viruses, bacteria, and fungi in an extremely short amount of time. However, it can be only be used in an enclosed environment due to the hazardous nature of the intensity and dosage of UVC radiation required for complete disinfection of large surface areas.

All of the above methods suffer from the disadvantage that are all carried out intermittently, infrequently and during intervals, meaning survived microorganisms continue to colonise and contribute to spreading contamination through contacts.

Surface coatings offer an alternative and continuous method of disinfection. These coatings typically include a number of materials from photocatalysts to various biocides, either used alone or as a combination. However, the use of biocides in antimicrobial coatings efficiently and effectively is limited by the trade between the maximum allowable (according to HSE regulations) level and the minimum effective concentration of the biocides in coatings

Photocatalysis has been used in continuous decontamination and disinfection on hard surfaces for many years. Titania photocatalysts are commonly used due to their insolubility in water, low toxicity and low costs. Titania has two crystalline forms, anatase and rutile, with anatase titania having a higher photocatalytic efficiency out of the two. However, this high photocatalytic activity contributes to premature failure in organic binders in coating formulations, meaning the use of anatase titania is limited to fewer applications. Even though rutile is used in organic coatings as a filler, this form is less effective as a photocatalyst. Therefore, the effectiveness of titania based antimicrobial coating is limited by the low photocatalytic efficiency of rutile titania on disinfection and the detrimental effect of anatase titania on coating robustness.

In light of the above it is an object of embodiments of the present invention to provide a coating having improved biocidal activity.

It is also an object of embodiments of the present invention to improve the robustness of coatings having biocidal activity.

It is another object of embodiments of the present invention to provide a biocidal material for incorporation into a coating composition.

It is a further object of embodiments of the present invention to provide a cost-effective method for producing the biocidal material and coatings comprising the biocidal material.

### SUMMARY OF THE INVENTION

According to a first aspect of the invention there is provided a biocidal nanocomposite comprising graphene, a photocatalyst and a biocide.

The nanocomposite exhibits improved biocidal activity and robustness relative to materials which comprise photocatalysts or biocides independently. In particular, the photocatalyst and the biocide are together able to provide improved continuous disinfection of hard surfaces. Moreover, the inventors have found that graphene acts as an electron mobiliser for the photocatalytic reaction which enables improvements in the photocatalytic efficiency of the photocatalyst to be obtained compared to photocatalysts used alone. As a consequence, the nanocomposite provides an enhanced disinfecting effect relative to conventional materials and/or formulations comprising photocatalysts. The presence of graphene in the nanocomposite also provides enhanced coating robustness due to its inherent strength and because it is able to protect the binder in the coating from photocatalytic degradation. It has also been found that graphene is very suitable for supporting and stabilising biocides which allows them to be released from the nanocomposite with greater control and over extended periods of time.

The graphene may comprise graphene nanoplatelets, few-layer graphene or mono-layer graphene. When the nanocomposite comprises graphene nanoplatelets or few-layer graphene the biocide may be distributed between adjacent graphene sheets which enables greater quantities of the biocide to be incorporated into the nanocomposite. When the nanocomposite is incorporated into a coating, graphene also acts as a barrier to oxygen and moisture which increases the longevity of the coating matrix.

The photocatalyst may be excited at a wavelength of 320-400 nm. Suitably the photocatalyst may be excited at a wavelength of 320-385 nm. At these wavelengths the photoexcitation of the photocatalyst occurs upon exposure to sunlight. Therefore, coatings or systems comprising the nanocomposite are able to provide continuous decontamination of surfaces in most applications.

The photocatalyst may comprise a metal oxide. In some embodiments the metal oxide may comprise titanium dioxide. The photocatalyst may comprise anatase titanium dioxide or rutile titanium dioxide. The presence of graphene in the nanocomposite promotes the transport of the electrons in the photocatalytic reaction when rutile titania is used leading to improvements in the photocatalytic efficiency of rutile titania. The presence of graphene in the nanocomposite has been found to reduce the detrimental effects on coating robustness when anatase titania is incorporated into surface coatings. In some embodiments the photocatalyst may comprise zinc oxide (ZnO), and/or Copper oxides (Cu2O and CuO).

The biocide may comprise metal nanoparticles. In particular, the biocide may comprise copper and/or silver nanoparticles. Suitably, the biocide may comprise silver coated copper nanoparticles. Copper and silver nanoparticles both exhibit very good biocidal activity which enables the nanocomposite to provide an enhanced biocidal effect relative to materials comprising photocatalysts and biocides independently. Further improvements in biocidal activity have been obtained by using silver coated copper nanoparticles.

The nanocomposite may comprise a chemical linker for attaching the photocatalyst to graphene. The chemical linker may comprise a siloxane or an organosilane, suitably an aminosilane. In particular, the chemical linker may comprise 3-Aminopropyl) triethoxysilane (APTES).

The graphene: metal nanoparticles ratio in the nanocomposite may be from 10:1 to 2:1.

According to a second aspect of the invention there is provided a method of preparing a biocidal nanocomposite, the method comprising:
a) preparing a first mixture comprising a dispersion of graphene, a photocatalyst and a chemical linker for attaching the photocatalyst to graphene;
b) preparing a second mixture comprising metal nanoparticles, and
c) combining the first mixture and the second mixture to obtain the biocidal nanocomposite.

The method according to the second aspect of the invention is particularly suitable for preparing the nanocomposite according to the first aspect of the invention. Accordingly, the method according to the second aspect of the invention may, as appropriate, include any or all of the features described in relation to the first aspect of the invention.

The first mixture may be subjected to a high shear mixing treatment. High shear mixing of the first mixture may be carried out at 6000-9000 rpm. In some embodiments the first mixture may be mixed at 8000 rpm. High shear mixing the first mixture between 6000-9000 rpm enables greater quantities of few layer graphene to be obtained.

The pH of the first mixture may be adjusted to an alkaline pH. Suitably, the pH of the solution may be mildly alkaline. For example, the pH may be from pH 8 to pH 9.

The chemical linker may comprise an aminosilane such as APTES. Suitably, APTES is hydrolysed prior to it being added to the first mixture. This may be achieved by mixing APTES with water, suitably demineralised water. The pH of the hydrolysed APTES solution may be adjusted to between pH 7 and pH9. Suitably, the pH of the solution may be mildly alkaline. For example, the pH may be from pH 8 to pH 9.

The second mixture may be in the form of an emulsion comprising the metal nanoparticles. Suitably, the second mixture may be in the form of a micro-emulsion. The emulsion or micro-emulsion may be prepared by mixing glycerine and an alcohol. Glycerine prevents or minimises oxidation of the metal nanoparticles. The alcohol may comprise iso-propyl alcohol. The metal nanoparticles may be added to the emulsion or micro-emulsion. The emulsion or micro-emulsion may be stirred at 5000-7000 rpm. Suitably the emulsion or micro-emulsion may be stirred at 6000 rpm.

To obtain the nanocomposite, the second mixture may be added to the first mixture. When adding the second mixture to the first mixture the first mixture may be stirred at low speed, e.g., at 500-700 rpm.

The first mixture may comprise 0.5-5 wt % graphene. In particular, the first mixture may comprise 1-5 wt % graphene. Suitably, the first mixture may comprise 1-3% graphene. If the first mixture comprises less than 0.5 wt % graphene then the photocatalytic efficiency of the photocatalyst is not increased or only increased by a small extent. Moreover, when the nanocomposite is incorporated into a coating, no noticeable improvements in coating robustness are observed. If the mixture comprises more than 0.5 wt % metal nanoparticles then a proportion of those metal nanoparticles will be present in the nanocomposite as loose particles. In use, the loose particles can be leached into the environment which may contribute to the failure of coatings that comprise the nanocomposite.

The first mixture may comprise 1-3 wt % metal nanoparticles. Suitably, the first mixture may comprise 1.5-3 wt % or 2-3 wt % metal nanoparticles. A metal nanoparticle content of less than 1 wt % results in a nanocomposite with reduced biocidal activity, especially over longer periods because the low volume of metal nanoparticles in the nanocomposite will be readily consumed.

According to a third aspect of the invention there is provided a coating composition, wherein the composition comprises the nanocomposite according to the first aspect of the invention or the nanocomposite produced according to the second aspect of the invention. Accordingly, the coating composition according to the third aspect of the invention may, as appropriate, include any or all of the features described in relation to the first and second aspects of the invention.

The coating composition may comprise at least 50 w/w % of the nanocomposite. When the coating composition contained at least 50 w/w % bacterial reduction could be reduced by more than 90%. The coating composition may comprise 50-75 w/w % or 50-60 w/w % of the nanocomposite. Further increases in bacterial reduction could be obtained by increasing the nanocomposite content in the coating to 60 w/w % and to 75 w/w %. When the nanocomposite content in the coating was less than 50 w/w %, e.g., 25 w/w % then the efficacy of coatings comprising the nanocomposite was significantly reduced. Therefore, to achieve an acceptable level of bacterial reduction the coating composition may contain more than 25 w/w % of the nanocomposite, e.g., 30 or 40 w/w % of the nanocomposite.

The coating composition may comprise a resin. Suitably, the resin may be an organic or an inorganic resin, e.g., an acrylic resin, a polyurethane resin or an epoxy resin. In some embodiments the coating composition may comprise a one-pack acrylic emulsion, a one-pack polyurethane emulsion, a two-pack acrylic emulsion or a two-pack epoxy emulsion. When the coating composition is to be applied on a transparent or highly decorative surface the binder may comprise an acrylic resin or a polyurethane resin. Such resins are suitable for use in both internal and external environments.

The nanocomposite may be present as a pigment in the coating composition. Other pigments include fillers such as calcium carbonate silica, BaSO₄, kaolin, mica, micaceous iron oxide, talc or combinations thereof.

The coating composition may comprise one or more of the following additives: a surfactant, a dispersing agent, a defoamer. The surfactants and/or dispersing agents may comprise anionic surfactants, non-ionic surfactants, cationic surfactants, amphoteric surfactants, polymeric surfactants and combinations thereof.

According to a fourth aspect of the invention there is provide a coated substrate, wherein the substrate comprises a coating layer formed from the coating composition according to third aspect of the invention.

The coated substrate according to the fourth aspect of the invention may, as appropriate, include any or all of the features described in relation to the first, second and third aspects of the invention.

The substrate may comprise masonry walls, wood, ceramics, metals, glass or plastics. In particular, the substrate may comprise walls, doors, tiles or handles.

The coating layer may have a dry film thickness of 1-5 microns. In some embodiments the dry film thickness may be 1-2 microns.

### DETAILED DESCRIPTION OF THE INVENTION

In order that the invention may be more clearly understood one or more embodiments thereof will now be described, by way of example only, with reference to the accompanying drawings, of which:

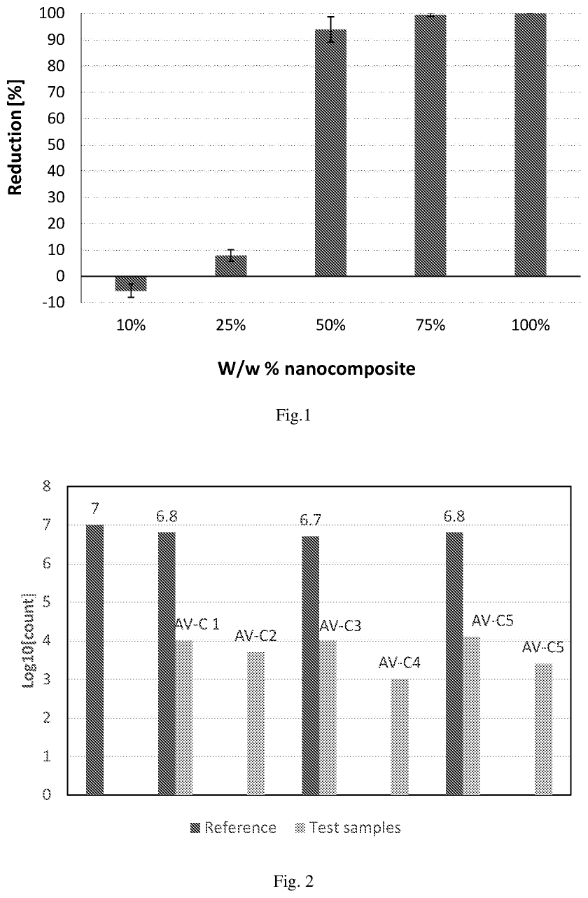

FIG. 1 shows the results of a study for determining an effective concentration of nanoparticles in coatings for achieving an acceptable level of bacterial reduction on surfaces.

FIG. 2 shows the results of a study for determining the efficacy of coatings containing the nanocomposite against viruses (H3N2 MDCK).

### EXAMPLE 1: BIOCIDAL NANOCOMPOSITE PREPARATION

In one example a biocidal nanocomposite is prepared by adding 200 g of 5% w/w dispersion of few-layer graphene (Ceylon Graphite) in water to a container. The pH of the dispersion is adjusted to pH 8 using dilute sodium hydroxide before 1 g of a dispersing agent (Disperbyk 2010) is added to the container. Then, 5 g of rutile titania powder is added to the container and this mixture is stirred at 8000 rpm using a high shear mixer for two hours. 10 g of hydrolysed 3-Aminopropyl) triethoxysilane (APTES) is then added to the mixture which is then stirred at 8000 rpm for a further hour.

To prepare hydrolysed APTES, 5 g of APTES is added 5 g of demineralised water, the pH of the APTES solution is adjusted to pH 8 using ammonia and then the solution is stirred for one hour.

In a separate container 5 g of glycerine is mixed with 75 g iso-propyl alcohol at 6000 rpm for 10 minutes to form a micro-emulsion. 4 g of silver coated copper powder (eConduct 122000 from Eckart) is then added to the micro-emulsion at the same speed.

The micro-emulsion comprising the silver coated copper nanoparticles is then added to the mixture containing few-layer graphene, rutile titania and hydrolysed APTES at low speed (˜600 rpm) for 10 minutes to obtain the biocidal nanocomposite.

### EXAMPLE 2: BIOCIDAL NANOCOMPOSITE PREPARATION

In a second example a biocidal nanocomposite is prepared by adding 200 g of 5% w/w dispersion of few-layer graphene (Ceylon Graphite) in water to a container. The pH of the dispersion is adjusted to pH 8 using dilute sodium hydroxide before 2 g of a dispersing agent (Disperbyk 2010) is added to the container. Then, 1 g of anatase titania powder is added to the container and this mixture is stirred at 8000 rpm using a high shear mixer for two hours. 10 g of hydrolysed 3-Aminopropyl) triethoxysilane (APTES) is then added to the mixture which is then stirred at 8000 rpm for a further hour.

To prepare hydrolysed APTES, 5 g of APTES is added 5 g of demineralised water, the pH of the APTES solution is adjusted to pH 8 using ammonia and then the solution is stirred for one hour.

In a separate container 5 g of glycerine is mixed with 75 g iso-propyl alcohol at 6000 rpm for 10 minutes to form a micro-emulsion. 3 g of silver coated copper powder (eConduct 042500 from Eckart) is then added to the micro-emulsion at the same speed.

The micro-emulsion comprising the silver coated copper nanoparticles is then added to the mixture containing few-layer graphene, anatase titania and hydrolysed APTES at low speed (˜600 rpm) for 10 minutes to obtain the biocidal nanocomposite.

### Coating Composition

The biocidal nanocomposites may be incorporated into any suitable resin system for producing a biocidal coating on a surface. The nanocomposites may be added to a pre-formulated coating at an appropriate ratio depending on the characteristics of the surface to which the coating will be applied, the conditions to which the coating will be exposed to in use and the type of disinfection that is required.

### Biocidal Coating Composition Preparation

### EXAMPLE: AV-C1

The following acrylic coating compositions were prepared as described:

| Material | Specification | % w/w |
|---|---|---|
| Nanocomposite | Example 1 | 50 |
| Resin | Acrylic emulsion (Ankote 2403, | 28 |
| | Wanhua Chemicals) | |
| Filler | Calcilit (Alpha Calcit) | 7 |
| Dispersing agent | Disperbyk 2010 (BYK) | 1 |
| Defoamer | BYK 057 (BYK) | 0.25 |
| Surface additives | BYK 342 | 0.25 |
| Solvent | Demineralised water | 13.5 |

The composition was prepared by adding a solvent, a dispersing agent and a defoamer to container. This was then mixed at 600 rpm. A Thereafter, a filler is added to the container and this mixture is high shear mixed at 8000 rpm for two hours. An acrylic emulsion is then added to the container at low speed (600 rpm) for 10 minutes before 1.5 g of surface additives are added to the mixture. The nanocomposite dispersion is then added to the mixture which is then at 600 rpm for 10 minutes.

### EXAMPLE: AV-C2

Using a similar procedure to that described in example AV-C1, the following coating composition was compared:

| Material | Specification | % w/w |
|---|---|---|
| Nanocomposite | Example 1 | 60 |
| Resin | Acrylic emulsion (Ankote 2403, | 25 |
| | Wanhua Chemicals) | |
| Filler | Calcilit (Alpha Calcit) | 5 |
| Dispersing agent | Disperbyk 2010 (BYK) | 1 |
| Defoamer | BYK 057 (BYK) | 0.25 |
| Surface additives | BYK 342 | 0.25 |
| Solvent | Demineralised water | 8.5 |

### EXAMPLE: AV-C3

Using a similar procedure to that described in example AV-C1, the following coating composition was compared:

| Material | Specification | % w/w |
|---|---|---|
| Nanocomposite | Example 2 | 50 |
| Resin | Polyurethane emulsion | 39 |
| | (Alberdingk U9000VP) | |
| Defoamer | BYK 028 (BYK) | 0.5 |
| Surface additives | BYK 349 | 0.5 |
| Solvent | Demineralised | 10 |
| | water:Dowanol (1:1) | |

### EXAMPLE: AV-C4

Using a similar procedure to that described in example AV-C1, the following coating composition was compared:

| Material | Specification | % w/w |
|---|---|---|
| Nanocomposite | Example 2 | 75 |
| Resin | Polyurethane emulsion | 20 |
| | (Alberdingk U900 VP) | |
| Surface additives | BYK 349 | 0.25 |
| Solvent | Demineralised | 4.75 |
| | water:Dowanol (1:1) | |

### EXAMPLE AV-C5

Using a similar procedure to that described in example AV-C1, the following coating composition was compared:

| Material | Specification | % w/w |
|---|---|---|
| Nanocomposite | Example 1 | 50 |
| Resin | Polyurethane emulsion | 30 |
| | [Alberdingk U 9190] | |
| Filler | Calcilit (Alpha Calcit) | 5 |
| Dispersing agent | Disperbyk 2010 (BYK) | 1 |
| Defoamer | BYK 024 (BYK) | 0.25 |
| Surface additives | BYK 349 | 0.25 |
| Solvent | Demineralised water | 10.5 |
| Co-solvent | Dowanol DPnB (Dow Chemicals) | 3 |

### EXAMPLE AV-C6

Using a similar procedure to that described in example AV-C1, the following coating composition was compared:

| Material | Specification | % w/w |
|---|---|---|
| Nanocomposite | Example 1 | 60 |
| Resin | Polyurethane emulsion [Insert] | 25 |
| Filler | Calcilit (Alpha Calcit) | 4.0 |
| Dispersing agent | Disperbyk 2010 (BYK) | 1 |
| Defoamer | BYK 024 (BYK) | 0.25 |
| Surface additives | BYK 349 | 0.25 |
| Solvent | Demineralised water | 7.5 |
| Co-solvent | Dowanol DPnB (Dow Chemicals) | 2 |

### Study 1

### Anti-Microbial Efficacy Tests

Experiments were carried out to investigate the anti-microbial efficacy of coatings comprising the nanocomposites.

Acrylic-plate samples were polished using sand paper (1200 finesse) and the coating compositions (AV-C2) were applied by brush application onto the acrylic plates. The applied coatings were then cured at 60° C. for 10 minutes. Inoculum was prepared by diluting a bacterial suspension to a standardised concentration. Inoculum was then applied on the sample and covered with glass in order to obtain constant exposure of bacteria to the sample. Samples were put in an incubator at 37° C. and a relative humidity above 90%.

The obtained bacterial suspension was spread to agar plates after 0 h and 24 h exposure to the samples to determine the bacterial reduction. Bacterial reduction (R) was calculated as follows:

$$R = ( {U}_{t} - {U}_{o} ) - ( W - {U}_{o} )$$

Where Uₒ represents the average of the common logarithm of the number of viable bacteria recovered from the control samples immediately after inoculation, Uₜ is the average of the common logarithm of the number of viable bacteria recovered from control samples after 24 hours and W is the average of the common logarithm of the number of viable bacteria recovered from test samples after 24 hours.

Table 1 below shows the results of anti-microbial efficacy tests after 0 hours and after 24 hours on plastic substrates without any coating (control) and on plastic substrates with an acrylic coating.

TABLE 1

| | Background | AV-C2coating | AV-C2 coating |
|---|---|---|---|
| Bacteria | (U₀) | (Uₜ) | (W) |
| Ecoli | 1.32 | 3.69 | 0 |
| | 1.23 | 3.70 | 1 |
| | 1.76 | 3.71 | 0 |
| Average | 1.43 | 3.70 | 0.33 |
| R (E-coli) | 99.99% | | |
| S. aureus | 2.57 | 3.42 | 0 |
| | 2.41 | 3.46 | 0 |
| | 2.49 | 3.35 | 0 |
| Average | 2.49 | 3.41 | 0 |

| | |
|---|---|
| R (S. aureus) | 100% |

The results show that 99.99% and 100% bacterial reduction of E. coli and S. aureus could be achieved after 24 hours when coating compositions comprising the nanocomposite according to Example 1 are applied on plastic substrates.

### Study 2

### Anti-Microbial Efficacy Test—Determining of Effective Concentration

Further experiments were carried out to determine an effective concentration of the nanocomposite in the coating that enables an acceptable level of bacterial reduction to be achieved.

Samples were prepared in a similar manner to those prepared in study 1 except that Pseudomonas S bacteria were used in these experiments. In these experiments AV-C1 coating compositions were applied onto the acrylic plates. FIG. 1 shows the percentage bacterial reduction as a function of nanocomposite concentration in the coating. From FIG. 1, it can be concluded that a nanocomposite concentration above 25 w/w % is needed in order to achieve an acceptable level of bacterial reduction and that a nanocomposite concentration of 50 w/w % or more results in a bacterial reduction of more than 90%.

### Study 3

### Anti-Viral Efficacy Tests

Experiments were carried out to investigate the anti-viral efficacy of the coatings comprising the nanocomposites. Acrylic-plate samples were polished using sand paper (1200 finesse) and the coating composition was applied by brush application. The applied coating was then cured at 60° C. for 10 minutes.

Inoculum was prepared by diluting a viral suspension to a standardised concentration. Inoculum was then applied on the sample and covered with glass in order to ensure constant exposure of the sample to the virus. Samples were put in an incubator at 37° C. and a relative humidity above 90%.

The obtained viral suspension was spread to agar plates after 0 h and 5 minutes exposure to the samples to determine the viral reduction. Viral reduction was calculated as follows:

$$R = ( U t = 0 ) - ( U t = 5 )$$

Uₜ₌₀ is the average of the common logarithm of the number of viable viruses recovered from control samples after 0 minutes and Ut=5 is the average of the common logarithm of the number of viable viruses recovered from test samples after 5 minutes.

Table 2 below shows the results of anti-viral efficacy tests after 0 and 5 minutes on plastic substrates provided with the AV-C2 coating. The results indicate that a significant reduction (80%) in the amount of virus at the surface can be obtained in a relatively short period of time (5 minutes) by coating surfaces with coatings comprising the nanocomposite.

TABLE 2

| | | AV-C2 coating | AV-C2 coating |
|---|---|---|---|
| Virus | Background | (Uₜ₌₀) | (Uₜ₌₅) |
| H3N2 | 6.00 | 6.12 | 5.33 |
| | 6.00 | 6.00 | 5.43 |
| | 6.20 | 6.12 | 5.33 |
| Average | 6.07 | 6.08 | 5.38 |

| | |
|---|---|
| R H3N2 | 80% |

### Study 3

### Anti-Viral Efficacy Tests

Further experiments were carried out to investigate the anti-viral efficacy of the coatings comprising the nanocomposite against H3N2 MDCK. In particular, the effect of coating type and nanocomposite loading on anti-viral efficacy against H3N2 MDCK were investigated.

The samples were prepared in a similar manner to those described in study 2. Table 3 below summarises the coatings that were tested, the type of nanocomposite i.e., nanocomposites prepared according to Example 1 or Example 2, the amount of nanocomposite in the coating, the type of metal nanoparticle and its content in the coating.

TABLE 3

| Coating | | Nanocomposite | | Metal nanoparticle | |
|---|---|---|---|---|---|
| name | Resin | type | % (w/w) | type | % |
| AV-C1 | Acrylic Emulsion | 1 | 50 | eCopper 122000 | 0.7 |
| AV-C2 | Acrylic emulsion | 1 | 60 | eCopper 122000 | 0.8 |
| AV-C3 | Polyurethane | 2 | 50 | eCopper 042500 | 0.25 |
| AV-C4 | Polyurethane | 2 | 75 | eCopper 042500 | 0.75 |
| AV-C5 | Polyurethane | 1 | 50 | eCopper 122000 | 0.7 |
| AV-C6 | Polyurethane | 1 | 60 | eCopper 122000 | 0.8 |

FIG. 1 shows the results of the efficacy study for acrylic plate samples coated with AV-C1 to AV-C6, with the reference samples being uncoated acrylic plates.

From an analysis of the results for AV-C1 (acrylic) and AV-C5 (polyurethane) which have the same nanocomposite loading (50 w/w %) and the same metal nanoparticles (eCopper 122000) it can be concluded that the efficacy of the nanocomposite is largely unaffected by resin type. AV-C1 and AV-C2 are both acrylic coatings which comprise the nanoparticle prepared according to Example 1. However, they differ in terms of their metal nanocomposite loading with the AV-C1 and AV-C2 coatings containing 50 and 60 w/w % nanoparticles respectively. The results show that an increase in nanoparticle loading from 50 to 60 w/w % improves the efficacy of the coating against H3N2 MDCK viruses. A similar trend is also observed when comparing the equivalent polyurethane coatings AV-C5 and AV-C6. A comparison of the AV-C3 and AV-C4 coatings also revealed that a significant increase in efficacy against H3N2 MDCK can be obtained by increasing the metal nanoparticle loading from 50 to 75 w/w %. The polyurethane coatings AV-C3 and AV-C5 differ in the nanocomposites contain anatase and rutile titania photocatalysts respectively and also in type of metal nanoparticles the nanocomposites respectively contain. Despite these differences in nanocomposite composition no significant impact on efficacy is observed which indicates that the both nanocomposites are effective at reducing viruses at surfaces and that the photocatalytic efficiency of rutile titania can be improved to an extent where it is comparable to the photocatalytic efficiency of anatase titania.

The one or more embodiments are described above by way of example only. Many variations are possible without departing from the scope of protection afforded by the appended claims.

1. A biocidal nanocomposite comprising graphene, a photocatalyst and a biocide comprising metal nanoparticles, wherein the biocide comprises copper nanoparticles.

2. A nanocomposite according to claim 1, wherein the graphene comprises graphene nanoplatelets, few-layer graphene or mono-layer graphene.

3. A nanocomposite according to claim 1, wherein the photocatalyst is excited at a wavelength of 320-400 nm.

4. A nanocomposite according to claim 1, wherein the photocatalyst comprises titanium dioxide, zinc oxide or copper oxides.

5. A nanocomposite according to claim 1, wherein the photocatalyst comprises anatase titanium dioxide.

6. A nanocomposite according to claim 1, wherein the photocatalyst comprises rutile titanium dioxide.

7. A nanocomposite according to claim 1, wherein the biocide comprises copper and silver nanoparticles.

8. A nanocomposite according to claim 1, wherein the biocide comprises silver coated copper nanoparticles.

9. A nanocomposite according claim 1, wherein the nanocomposite comprises a chemical linker for attaching the photocatalyst to graphene.

10. A nanocomposite according to claim 9, wherein the chemical linker comprises an aminosilane.

11. A nanocomposite according to claim 1, wherein the graphene: metal nanoparticles ratio is from 10:1 to 2:1.

12. A method of preparing a biocidal nanocomposite, the method comprising:
a. preparing a first mixture comprising a dispersion of graphene, a photocatalyst and a chemical linker for attaching the photocatalyst to graphene;
b. preparing a second mixture comprising metal nanoparticles, wherein the metal nanoparticles comprise copper nanoparticles, and
c. combining the first mixture and the second mixture to obtain the biocidal nanocomposite.

13. A method according to claim 12, wherein the first mixture is subjected to a high shear mixing treatment.

14. A method according to claim 12, wherein the first mixture comprises 0.5 to 5 wt % graphene.

15. A method according to claim 12, wherein the first mixture comprises 1 to 3 wt % of the metal nanoparticles.

16. A coating composition, wherein the composition comprises the nanocomposite according to claim 1.

17. A coating composition according to claim 16, wherein the coating composition comprises at least 50 w/w % of the nanocomposite.

18. A coating composition according to claim 16, wherein the composition comprises an acrylic, a polyurethane or an epoxy resin.

19. A coating composition according to claim 16, wherein the composition comprises 0.2 to 1 w/w % metal nanoparticles.

20. (canceled)

21. A coated substrate, wherein the substrate comprises a coating layer formed from the coating composition according to claim 16.

22. (canceled)

23. (canceled)
